(19) United States
(12) Patent Application Publication
(10) Pub. No.: US 2008/0163766 A1
(43) Pub. Date: Jul. 10, 2008

(54) Processing Line For Producing Foods

(75) Inventor: Klaus Meyer, Breidenbach (DE)

Correspondence Address: FOLEY & LARDNER LLP, 777 EAST WISCONSIN AVENUE, MILWAUKEE, WI, 53202-5306, US

(73) Assignee: CFS Germany GmbH

(21) Appl. No.: 11/660,251

(22) PCT Filed: Aug. 16, 2005
(86) PCT No.: PCT/EP2005/054027

§ 371 Date: Sep. 25, 2007

(30) Foreign Application Priority Data
Aug. 16, 2004 (DE) 10 2004 039 793.7

(51) Int. Cl. A47J 44/00; B01J 19/00

(52) U.S. Cl. 99/485; 422/291

(57) ABSTRACT

The invention relates to a processing line for producing foods, such as sausage, ham or cheese. Said processing line comprises at least one processing device, a packaging device and transportation means. At least one partial area of the surface of the processing line has a permanently germ-free surface.

The object of the present invention is to provide a processing line for foods not showing the disadvantages of the prior art and/or for elongating the cleaning cycles.

The present invention relates to a processing line for producing and/or for the packaging of foods such as raw sausages, minced meat, sausage ham, cheese and/or food which are heat treated, for example which were fried. Said processing line comprises at least one processing device, a packaging device and/or a transportation mean, whereby at least one partial area of the surface of the processing line has a permanently germ-free surface.

Such processing lines are well known in the state of the art and show for example passing machines for hacking of fresh or frozen meat, mixers respectively cutter for mixing and/or emulsifying of foods, filling devices for filling foods in wrappings, for example natural or artificial intestines, devices wherein foods are heat treated, for example stoves, or cool treated, formed or provided with a coating, for example with a breadcrumb coating, peeler which removing the wrapping of a food, in particular sausage skins, slicers which cut the food bars in slices and/or packaging machines for the packing of foods. Often, the above mentioned processing machines are connected with each other via transportation means, for example via transport belts and/or the devices showing transportation means inwardly. Scale stations can be arranged between the transportation means or can be integrated into the transportation means.

Due to the foods, the humidity and the respective temperatures, such processing lines are a beneficial environment for the growth of micro organisms.

Therefore, known devices counter against the growth of micro organisms by continuous cleaning and/or disinfecting the processing, packaging machines and/or of the transportation means in relative short intervals. Thereby, disadvantages are the standstill time of the machine and that directly after the cleaning respectively after the disinfection the growth of the germs, fungi and/or spores started again and correspondingly the growth increases again.

The object is solved by a processing line for food with the characteristic features according to claim 1. Preferred embodiments are shown in the depended claims 2 to 17.

For the person skilled in the art it was surprisingly and not expected that the foods produced by the processing line according to the present invention show a lower germ number as products produced by a conventional processing line. The processing line according to the present invention is easy to manufacture and can be run with lower costs as processing lines according to the state of the art since these process lines have to be cleaned more rarely. The foods produced by the processing line according to the present invention are showing a lower germ number and therefore the foods have an improved storage live.

In the purpose of the invention, germ-free means to keep or to fall below the allowable and agreeable limit for the processing of foods. Preferably, germ-free means that the mesophile bioburden, measured in colony forming unit (CFU)/100 cm², is less than 1000, more preferably less than 250, in particular preferably less than 150, in particular more preferably less than 100 and most preferably less than 20.

In the purpose of the invention, durable means that the surfaces are keeping longer germ-free than a conventional stainless steel surface, preferably two times, more preferably three times, particular preferably four times, in particular more preferably five times and most preferably ten times. Therefore, the cleaning cycles can be reduced accordingly.

Durable germ-free surfaces are offering there an advantage in a processing line where machine parts get in contact with the food or parts anytime get in contact with the food like for example the package, or areas which are contaminated with foods, e.g. such areas which are difficult to clean.

The durable germ-free status can be achieved due that the germs cannot be deposited on the corresponding surfaces and/or that the germs are destructed on the surfaces and/or that the germs cannot proliferate on the surfaces. Preferably, the durable germ-free status of partial areas of the surface is achieved particularly by self disinfecting of these surfaces and/or self cleaning of these surfaces. Self cleaning/-disinfecting surfaces provide the advantage of a constant low germ load during the running operation of the processing line according to the present invention.

Preferably, the surface shows a layer which is able to oxidative degrade organic molecules as a catalysator. More preferably, such a layer consists of a semiconductor material like titanium dioxide. The photo catalysis is used for disinfection, so that in particular inaccessible parts can be kept germ-free without additional cleaning agents. In particular more preferably, a second photoconducting layer is arranged below the photoactivatable layer, wherein ultraviolet light, in particular UV-A light from a UV-light source is transmitted through the photoconduction layer to the first layer which will be activated thereby. The stimulation of the semiconductor layer with a light conductor lying below shows the beneficial possibility to perform self disinfected shadowed surfaces temporarily or permanent.

Furthermore, the self cleaning surface is performed hydrophobic, in particular ultra phobic. In terms of the present invention, a surface is hydrophobic like water- and/or oil/fat-resisting if a drop of 10 μl volumes is rolling up at an inclination <20° by means of force of gravity from the surface and adopts a contact angle >90° to the surface. A surface is ultra phobic if a water or oil drop adopts a contact angle >150° and rolling up at an inclination <10°.

Such surfaces are referred to self cleaning. Therefore, even smallest amounts of liquids are rolling up at a low inclination. Further, collected particles are removed with the drop.

Ultra phobic surfaces, the use thereof and processes for their manufacture are described for example in the German patent DE 198 60 136 C2, which is hereby incorporated by reference and therefore a part of the disclosure. Accordingly, an ultra phobic surface can be manufactured by structuring of a substrate and coating with hydrophobic material.

According to the present invention, the material used to form the ultra phobic surface is optional. In particular preferred, the surface of the machine itself is formed as the substrate. For example, this could be carried out in such a way that the surface of the respective machine is at least partly sandblasted and then provided with a hydrophobic or oleophobic coating, like described in the WO/00/38845 which is hereby incorporated by reference and therefore a part of the disclosure.

Even though the processing line according to the present invention shows substantial extended cleaning and disinfecting cycles compared to machines according to the prior art, however the processing line of the present invention shows additional conventional devices for cleaning or disinfection with liquid or gaseous substances or via irradiation in a preferred embodiment.

Preferably the total surface of the processing line according to the present invention shows a germ-free surface. In particular preferred, at least such parts of the processing line according to the present invention are provided with a durable germ-free surface, which directly or indirectly gets in contact with the food and/or with the packaging for the food. For hygienic purpose for example, it is very preferably that the belt conveyor, which is in contact with the foods for a relatively long time, should be designed durable germ-free. Further examples which are kept durable with a germ-free surface are deflection rolls, depositor for filling the package, moulding-, sealing- and cutting tool, portion belts or cutting means.

Further preferred is also the performance of such parts with a durable germ-free surface which are contaminated with the food by contact or with arising food scraps, whereby in the case of hydro- or ultra phobic surfaces it can be managed that the contamination can be decreased totally since the food scraps do not adheres on the surfaces. This is preferred since an all in all germ-free environment is provided.

In particular, the development of micro organisms in parts of the processing line which are bad available and therefore hard for cleaning, are deactivated a germ source.

A processing device in terms of the present invention is every machine which can be used for processing foods, for example passing machines for controlled crushing of fresh or frozen meat, mixer respectively cutter for mixing and/or emulsifying of foods, filling devices for filling foods in wrappings, for example nature—or artificial bowels, devices for heating treatment like for example kilns, or cooling treatment, formed or provide with a coat, for example a crump, peeler which are able to remove the coating of a food, particularly a sausage casing, slicers for cutting food bars into slices.

Foods in terms of the present invention are every food which serves particularly for the feeding of humans. Preferably, these foods are meat, sausage, cheese, ham and candies.

As a packaging device, preferably a form filling seal packaging machine is used in the processing line according to the present invention, which comprises a deep drawing-, an inlaid- and a seal station, or a so called traysealer wherein ready made forms are separated, filled and sealed, or horizontal or vertical pillow back apparatus (flowrapper).

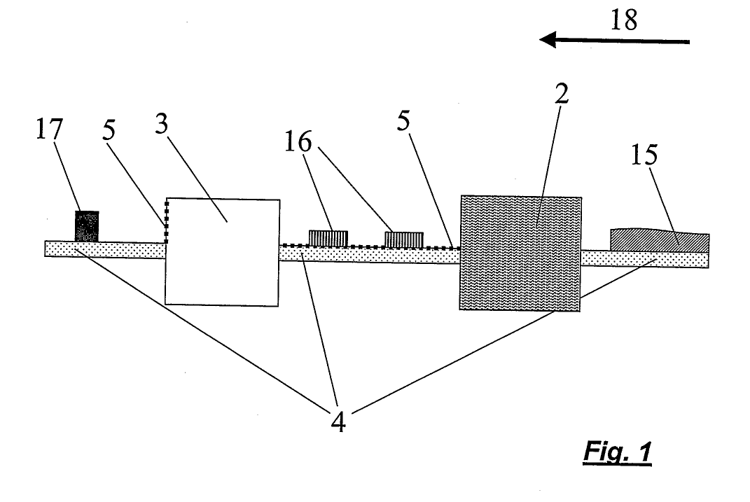

With references to FIGS. 1 to 4, the invention will be illustrated below. These illustrations are merely by way of example and do not limit the general idea of the invention.

FIG. 1 shows an embodiment of a processing line for food products schematically.

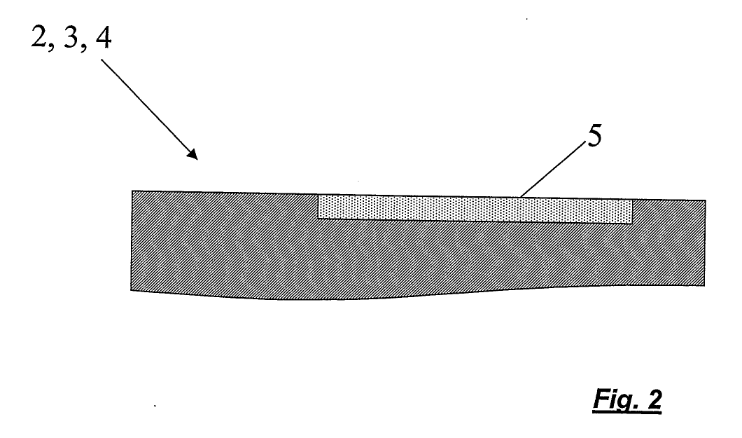

FIG. 2 shows a sectional drawing of a machine surface.

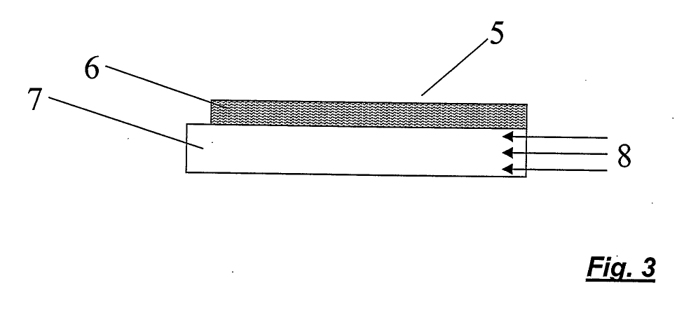

FIG. 3 shows the structure of an indirect photoactive surface.

In FIG. 1, a processing line for food products 1 is shown schematically. The producing and processing process is proceeding in the direction of the arrow 18. Food products 15, 16, 17 in different processing steps are moved by a transport means 4. The raw and intermediate product 15 is processed in a proceeding device 2, for example in a slicer. The proceeded product is transported to the packaging device 3 and is leaving this as a packed product 17. Parts of the surface are performed as durable germ-free surfaces 5.

FIG. 2 shows a sectional drawing of an arbitrary device 2, 3, 4 in the processing line according to the present invention 1, which partly has a durable germ-free surface 5. In the present case, the surface 5 is an ultra phobic surface on which a water drop takes a contact angle of 171° and the rolling up angle is ≦10°. Therefore, parts of the surface were sand blasted and then provided with a hydrophobic coating like described in WO/00/38845.

FIG. 3 shows a photo activatable layer 6. By means of the photo catalysis organic substances are oxidative degraded on the surface 5. Such surfaces are called self disinfected. The continually running degradation process provides durable for a low germ burden of the surface 5. The photo catalytic effect only occurs with continuing irradiation of the surface with ultraviolet light. However, it is irrelevant if that site of the photo activatable layer 6 is irradiated on which the catalytic reaction takes place or another site. Therefore it is very preferable possible to carry out the irradiation of the layer 6 with UV light 8 through a light conductor 7. In this case, the photo activatable layer 6 cannot be shadowed. Also if objects are still on the surface 5, the process of the photo catalysis is running below unrelieved.

### LIST OF THE REFERENCE NUMBERS

1. processing line
2. processing device
3. packaging device
4. transport means
5. permanent germ-free surface
6. first layer
7. second layer
8. ultraviolet light
9. raw- or intermediate product
10. processed product
11. packed product
12. production direction

1-15. (canceled)

16. A processing line for processing foods, comprising:
at least one of a processing device, a packaging device, and a transportation means;
wherein the at least one of the processing device, the packaging device, and the transportation means includes a durable germ-free surface that is self disinfecting and/or self cleaning such that the durable germ-free surface shows hydrophobic or ultra phobic properties resulting from the structure of the durable germ-free surface and a water resistant coating.

17. A processing line according to claim 16, wherein the durable germ-free surface includes at least a first layer configured to oxidatively degrade germs and/or organic molecules.

18. A processing line according to claim 17, wherein the first layer includes a semiconductor material.

19. A processing line according to claim 18, wherein the semiconductor material is titanium dioxide.

20. A processing line according to claim 16, wherein the durable germ free surface includes a second layer below the first layer, the second layer being photoconducting wherein ultraviolet light can be conducted.

21. A processing line according to claim 20, wherein the ultraviolet light is long wave UV-A light.

22. A processing line according to claim 16, further comprising:
an additional device for disinfection using at least one of a gas, a liquid, and irradiation.

23. A processing line according to claim 16, wherein at least a portion of the durable germ-free surface contacts the foods and/or packages.

24. A processing line according to claim 16, wherein the portion of the durable germ-free surface that contacts the foods and/or the packages includes a surface that is inaccessible by a user of the processing line.

25. A processing line according claim 16, wherein the processing device is a cutting device with a rotating driven blade in a rotor case.

26. A processing line according to claim 25, wherein an inner wall of the rotor case is provided at least partly with the durable germ-free surface.

27. A processing line according to claims 16, wherein the processing device includes at least one of a passing machine and a cutter for controlled crushing and/or emulsifying of foods.

28. A processing line according to claim 16, wherein the processing device is a peeler for removing the covers of the packages of food bars.

29. A processing line according to claim 16, wherein the packaging device is a form filling sealing packaging apparatus with a deep drawing station, an inlaid station, and a seal station.

30. A processing line according to claim 16, wherein the packaging device is a traysealer with a packaging separation station, an inlaid station, and a seal station.

31. A processing line according to claim 16, wherein the packaging device includes at least one of a horizontal flowrapper and a vertical flowrapper and has a conveyor for a product, a forming- and/or filling station, and a longitudinal- and/or transverse sealing station.

32. A processing line according to claim 16, wherein the processing device is a device for at least one of heating treatment, cooling treatment, and marinating of foods.
